(19) United States
(12) Patent Application Publication
(10) Pub. No.: US 2020/0101974 A1
(43) Pub. Date: Apr. 2, 2020

(54) DEVICE AND METHOD FOR SELECTING OPTIMAL TRAVEL ROUTE BASED ON DRIVING SITUATION

(71) Applicant: LG ELECTRONICS INC., Seoul (KR)

(72) Inventors: Dae Geun HA, Seoul (KR); Junyoung YU, Seoul (KR); Soojung JEON, Seoul (KR)

(73) Assignee: LG ELECTRONICS INC., Seoul (KR)

(21) Appl. No.: 16/557,940

(22) Filed: Aug. 30, 2019

(30) Foreign Application Priority Data
Aug. 12, 2019 (KR) 10-2019-0098431

(51) Int. Cl. B60W 30/18; G05D 1/00; B60W 40/04; B60W 40/06; G01C 21/34; H04W 4/40

(52) U.S. Cl. CPC B60W 30/18163; G05D 1/0088; B60W 40/04; B60W 40/06; G05D 2201/0213; H04W 4/40; B60W 2550/402; B60W 2550/20; B60W 2550/14; G01C 21/3492

(57) ABSTRACT

A device and a method that allow selection of an optimal travel route by creating a route considering a real-time driving environment in an autonomous driving vehicle are disclosed. The method includes receiving at least one of surrounding situation information or road situation information from a cloud; calculating a score about each of a plurality of lanes of a road based on the at least one of the surrounding situation information or the road situation information; and configuring a travel route based on the calculated scores. The device and method may be associated with an AI (artificial intelligence) device, a drone, an UAV (unmanned aerial vehicle), a robot, an AR (augmented reality) device, a VR (virtual reality) device, and a 5G service.

### CROSS-REFERENCE TO RELATED APPLICATION(S)

Pursuant to 35 U.S.C. § 119(a), this application claims the benefit of earlier filing date and right of priority to Korean Patent Application No. 10-2019-0098431, filed on Aug. 12, 2019, in the Korean Intellectual Property Office, the contents of which are hereby incorporated by reference herein in their entirety.

### BACKGROUND

### 1. Technical Field

Embodiments of the present disclosure relate to a device and a method for selecting an optimal travel route by generating a travel route in consideration of a real-time driving environment in an autonomous driving vehicle.

### 2. Description of the Related Art

Recently, technology development for an autonomous driving vehicle that autonomously drives to a destination by itself without operation (e.g., steering) by a driver has been made. According to the development of the autonomous driving vehicle, a variety of activities by an occupant thereof may be available while the autonomous driving vehicle is moving. Various services provided to passengers in the vehicle as the service customer are expected to be one of the future industries.

The autonomous driving vehicle recognizes vehicles, pedestrians, and obstacles on the road using sensors such as a radar, lidar, and camera mounted on the vehicle. Then, the autonomous driving vehicle determines a driving situation, and performs a spacing maintenance, a lane keeping, and a lane change based on a driving situation.

Further, the autonomous driving vehicle sends a current situation to a server depending on a traffic situation. The server provides, to the autonomous driving vehicle, driving information including a travel route based on safety of the autonomous driving vehicle, traffic efficiency on the road, environment friendliness via fuel savings, and convenience.

However, the travel route for autonomous driving may be defined as a candidate route along which the vehicle can move among predefined candidate routes. Because types of candidate routes may be increased by an indefinite amount depending on locations of the vehicle and states of the vehicle, it may be very difficult to create the candidate routes in advance.

Further, since the route planning is made by selecting one of the candidate routes, a state of a road should be fully reflected when creating the candidate routes.

Korean Patent No. 10-1332205 (2013.11.18) may support more stable vehicle operation by integrating and providing real-time situation information such as weather information, disaster information, traffic information, road situation information, accident information, etc. that affect the vehicle operation.

FIG. 1 schematically shows a conventional intelligent moving vehicle control system.

Referring to FIG. 1, the conventional intelligent moving vehicle control system includes a vehicle information collection device 10, a telematics terminal 20, an AVL (automatic vehicle locator) server 30 and an information server 40.

The vehicle information collection device 10 automatically communicates with an ECU (Electronic Control Unit), as an engine control computer, and a TCU (Transmission Control Unit) as a transmission control computer during key-on of the vehicle via an OBD (On-Board Diagnostic)-II terminal inside the vehicle. Then, the vehicle information collection device 10 collects driving information of the vehicle, status information of the vehicle, and fault diagnosis code (DTC code), and provides the collected data to the telematics terminal 20.

The telematics terminal 20 connects to the AVL server 30 via a wireless network (3G/WiFi), receives real-time situation information from the AVL server 30 and provides the information to a driver.

The AVL server 30 collects and integrates real-time situation information such as weather information, disaster information, traffic information, road situation information, accident information, etc. that affect vehicle operation from an external information server 40, and provides the integrated information to the telematics terminal 20.

Thus, the conventional intelligent moving vehicle control system may support more stable vehicle operation by integrating and providing, to the vehicle, the real-time situation information such as weather information, disaster information, traffic information, road situation information and accident information that affect vehicle operation.

As such, in the conventional intelligent moving vehicle control system, the telematics terminal 20 mounted in the vehicle collects various vehicle information from the ECU (Electronic Control Unit) and transmits the collected information to the AVL server 30. Then, the vehicle status and driving pattern information are analyzed by the AVL server 30, which, in turn, feeds back the analysis result to the telematics terminal 20 to inform the driver of danger. However, the real-time situation information collected by the AVL server 30 only contains vehicle information such as driving information of the vehicle, vehicle status information, and fault diagnosis code (DTC code).

Further, in the conventional intelligent moving vehicle control system, the AVL server 30 collects real-time situation information such as weather information, disaster information, traffic information, road situation information, accident information, etc. that affect vehicle operation from the external information server 40 and integrates the collected real-time situation information and then provides integrated information to the telematics terminal 20. However, the real-time situation information collected by the AVL server 30 only contains limited information such as weather information or traffic information.

That is, the information collected by the AVL server 30 does not include information on surrounding situations such as road surface conditions (slippery, frozen, or damaged), accident information, construction/working sections, etc. Thus, there is a problem that the information that the driver may utilize for safe driving is not various (or suitably wide ranging). In particular, a fuel efficiency, and a degree of (risk of potential) damage to the vehicle may vary depending on a state of the driving road, and a type and behavior of a surrounding vehicle.

As such, there are state parameters that vary in real-time. Thus, the conventional intelligent moving vehicle control system may not create an optimal travel route while using known parameters.

### SUMMARY

An aspect of the present disclosure is directed towards providing a device and method that allow selection of an optimal travel route by creating a route considering a real-time driving environment in an autonomous driving vehicle.

Further, an aspect of the present disclosure is directed towards providing a device and method that allow selection of an optimal travel route based on a driving situation via a collection of data that may cause a change in the driving environment from a number of driving vehicles, and via provision of a variety of information related to safe driving based on the collection.

Further, as aspect of the present disclosure is directed towards providing a device and method in which a route is selectable and a road is divided in multiple lanes and a preferred lane is selectable.

Aspects of the present disclosure are not limited to the aspects described above. Other aspects and advantages of embodiments of the present disclosure not mentioned above may be understood from the following description and more clearly understood with reference to various embodiments of the present disclosure. Further, it will be readily appreciated that aspects and advantages of embodiments of the present disclosure may be realized by features and combinations thereof as disclosed in the claims.

An optimal travel route selection device and method based on a driving situation according to at least one embodiment of the present disclosure may store information of a vehicle equipped with a sensor that can measure a road surface condition, and a position and type (truck, passenger car, etc.) of a recognized nearby vehicle in a cloud and may divide the road into several lanes and may update each lane score based on the data stored in the cloud.

An optimal travel route selection device and method based on a driving situation according to at least one embodiment of the present disclosure may calculate a score for each lane based on surrounding situation information and road situation information collected from a plurality of autonomous driving vehicles and may select a travel route based on the scores.

An optimal travel route selection device and method based on a driving situation according to at least one embodiment of the present disclosure may calculate preference-based lane scores by applying different weights corresponding to different user preference modes to each calculated lane score.

An optimal travel route selection device based on a driving situation according to at least one embodiment of the present disclosure may include an information receiver for collecting at least one of surrounding situation information and road situation information from an autonomous driving vehicle; a score calculating unit for calculating a lane score about each lane of a road based on at least one of the surrounding situation information and the road situation information; and a travel route managing unit for configuring a travel route based on the calculated lane scores.

An optimal travel route selection method based on a driving situation according to at least one embodiment of the present disclosure includes collecting at least one of surrounding situation information and road situation information from an autonomous driving vehicle; calculating a lane score about each lane of a road based on at least one of the surrounding situation information and road situation information; and configuring a travel route based on the calculated scores.

An optimal travel route selection method based on a driving situation according to at least one embodiment of the present disclosure may include calculating each lane score using parameters including surrounding situation information such as at least one of a vehicle or a pedestrian on the road, and/or road situation information such as information about at least one of road surface states (slippery/frozen/damaged states), an accident, a construction/working section, etc.

An optimal travel route selection method based on a driving situation according to at least one embodiment of the present disclosure may include calculating preference-based lane scores by applying different weights corresponding to different user preference modes to each calculated lane score.

Effects of embodiments of the present disclosure are disclosed as follows but are not limited thereto.

The optimal travel route selection devices and methods based on the driving situation according to embodiments of the present disclosure may allow selection of an optimal travel route by creating a route considering a real-time driving environment in an autonomous driving vehicle.

Further, the optimal travel route selection devices and methods based on the driving situation according to embodiments of the present disclosure may allow selection of an optimal travel route based on a driving situation via collection of data that may cause a change in the driving environment from a number of driving vehicles, and via provision of a variety of information related to safe driving based on the collection.

Further, the optimal travel route selection devices and methods based on the driving situation according to embodiments of the present disclosure may allow a travel route to be selectable and allow the road to be divided in multiple lanes and allow a preferred lane to be selectable. Thus, the vehicle may avoid damaged roads, temporary roads, and dirty roads.

Furthermore, the optimal travel route selection device and method based on the driving situation according to embodiments of the present disclosure can protect the vehicle and improve fuel economy because the device and method can identify and avoid damaged roads, temporary roads, and dirty roads before the vehicle enters the damaged roads, temporary roads, and dirty roads.

Furthermore, the optimal travel route selection devices and methods based on the driving situation according to embodiments of the present disclosure may select an optimal travel route based on a travel distance, handling, surrounding vehicle(s), and road surface state, such that the fuel consumption, (risk of) vehicle damage, driving time, and air resistance may be reduced.

In addition to the effects as described above, specific effects of embodiments of the present disclosure are described together with specific details for carrying out embodiments of the present invention.

### BRIEF DESCRIPTION OF DRAWINGS

FIG. 1 is a schematic diagram of a conventional intelligent moving vehicle control system.

FIG. 2 is a block diagram of a system for optimal travel route selection based on a driving situation according to at least one embodiment of the present disclosure.

FIG. 3 is a block diagram showing a detailed configuration of a portion of an autonomous driving vehicle according to at least one embodiment.

FIG. 4 is a flow chart illustrating an optimal travel route selection method based on a driving situation according to at least one embodiment of the present disclosure.

FIG. 5 illustrates an example of a method for detecting a presence of standing water or an existence of a frozen state using a sensor unit according to at least one embodiment of the present disclosure.

FIG. 6 illustrates an example of a method of detecting (existence of) road wear using a sensor unit according to at least one embodiment of the present disclosure.

FIG. 7 illustrates an example of a method for detecting a position and a size of a nearby vehicle using a sensor unit according to at least one embodiment of the present disclosure.

FIG. 8 illustrates an example of a method of detecting inclination of each lane using a sensor unit according to at least one embodiment of the present disclosure.

FIG. 9 is a block diagram of an AI device according to at least one embodiment of the present disclosure.

FIG. 10 is a block diagram of an AI server according to at least one embodiment of the present disclosure.

FIG. 11 is a block diagram of an AI system according to at least one embodiment of the present disclosure.

FIG. 12 to FIG. 17 illustrate methods of data communication over a 5G network according to various embodiments.

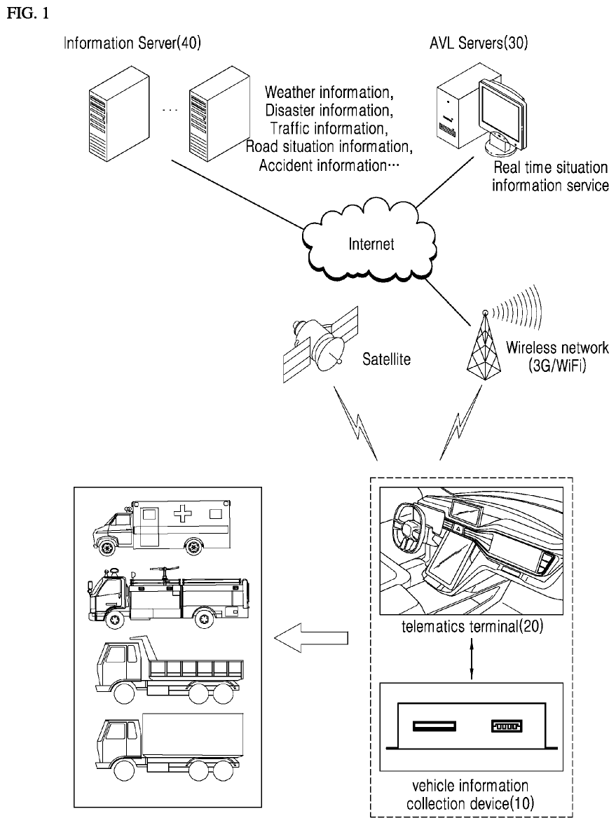

### DETAILED DESCRIPTIONS

For simplicity and clarity of illustration, elements in the figures are not necessarily drawn to scale. The same reference numbers in different figures denote the same or similar elements, and as such perform similar functionality. Furthermore, in the following detailed description of embodiments of the present disclosure, numerous specific details are set forth in order to provide a thorough understanding of the embodiments of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described in further detail below. It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is for the purpose of describing particular embodiments only and is not intended to be limiting with respect to the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will also be understood that when a first element or layer is referred to as being present “on” or “beneath” a second element or layer, the first element may be disposed directly on or beneath the second element or may be disposed indirectly on or beneath the second element with a third element or layer being disposed between the first and second elements or layers. It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Unless otherwise defined, all terms including technical and scientific terms used herein have the same meaning as commonly understood by one of ordinary skill in the art to which the inventive concept(s) belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Hereinafter, a device and method for selecting an optimal travel route based on a driving situation according to various embodiments of the present disclosure will be described in more detail.

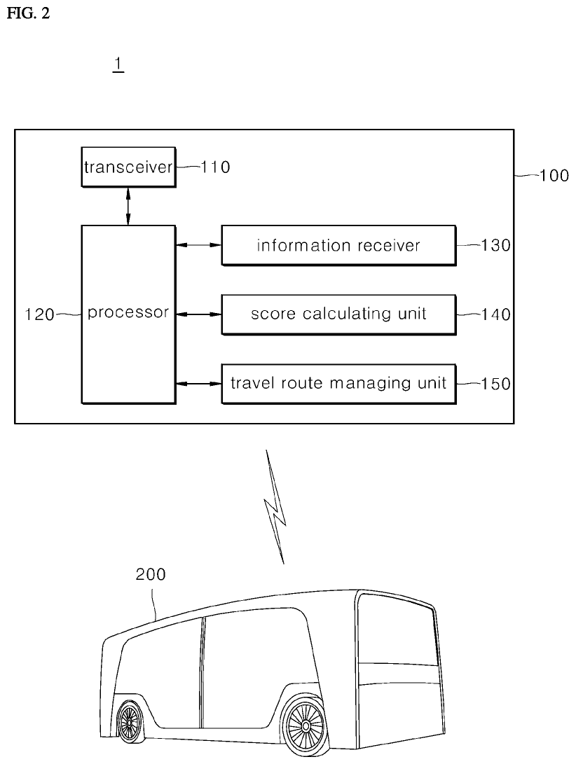

FIG. 2 is a block diagram of a system 1 for optimal travel route selection based on the driving situation according to at least one embodiment of the present disclosure. The overall system shown in FIG. 2 represents merely at least one embodiment. Components thereof are not limited to the embodiment as shown in FIG. 2. Some components may be added, changed or deleted as necessary.

As shown in FIG. 2, the system 1 for optimal travel route selection based on the driving situation may include a server 100 and an autonomous driving vehicle 200. In this regard, the system 1 for optimal travel route selection based on the driving situation represents merely at least one embodiment. The components thereof are not limited to the embodiment shown in FIG. 2. Some components may be added, changed or deleted as necessary.

The server 100 and the autonomous driving vehicle 200, which constitute the system 1 for optimal travel route selection based on the driving situation, may be connected to a wireless network and may perform mutual data communication with each other.

The server 100 may include a transceiver 110, a processor 120, an information receiver 130, a score calculating unit 140, and a travel route managing unit 150.

The transceiver 110 receives surrounding situation information and road situation information recognized in real-time from the autonomous driving vehicle 200 and/or another vehicle(s) via a wireless network and sends a route generated from the server 100 to the autonomous driving vehicle 200. In this regard, the surrounding situation information and the road situation information received from the autonomous driving vehicle 200 and/or another vehicle(s) may be stored in the cloud.

The information receiver 130 receives surrounding situation information and road situation information from the transceiver 110. In this regard, the surrounding situation information may include position information of other vehicles and position information of pedestrians existing (or present) on the road. Further, the road situation information may include road surface state information such as slippery/frozen/damaged states, accident information such as information on accidents occurring on the road, and work section information such as information on a section of a road in which construction or work is being performed. The information receiver 130 may further receive weather information and traffic information.

The score calculating unit 140 calculates a lane score of each lane of the road based on the surrounding situation information and the road situation information. That is, the score calculating unit 140 divides a driving road along a route from a preset origin to an arrival destination into multiple lanes. For example, the score calculating unit 140 calculates two lane scores when the number of multiple lanes is equal to two. In another example, the score calculating unit 140 calculates four lane scores when the number of multiple lanes is equal to four.

Then, the score of a particular lane may be calculated using the surrounding situation information and the road situation information as respective parameters. The score may be calculated by using weather information and traffic information as parameters.

Further, the score calculating unit 140 may calculate the preference based lane score by applying different weights corresponding to different preference modes to each calculated lane score. In this regard, the preference mode may include a ride comfort mode, a fuel consumption mode, a vehicle damage mode, a driving time mode, and the like.

The travel route managing unit 150 uses the calculated lane score or the calculated preference-based lane score to select a lane having the highest lane score or highest preference-based lane score as the optimal travel route.

The processor 120 may control operation and processing of the transceiver 110, information receiver 130, score calculating unit 140, and travel route managing unit 150.

The server 100 may have the same configuration as a normal (or typical) web server with respect to hardware. With respect to software, the server 100 may include program modules implemented using various languages such as C, C++, Java, Visual Basic, Visual C, etc. to perform various functions. The server 100 may be built based on a cloud. The collected information from the autonomous driving vehicle 200 connected to a wireless network may be stored in and managed by the server 100. The server 100 may be operated by a transportation company server, such as a car sharing company, or may control the autonomous driving vehicle 200 using wireless data communication.

The server 100 may connect to any transportation company server (not shown) and instruct a transportation company vehicle capable of moving to a position (or location) corresponding to an arrival position information to reach a position of the autonomous driving vehicle 200. In this regard, the transportation company server may be a server that manages the operation of any transportation company vehicle. For example, the transportation company server may be a server of a taxi company that manages driving of a manned taxi or an unmanned taxi (autonomous driving taxi).

The server 100 may identify a current position (or location) of the autonomous driving vehicle 200 via a GPS (global positioning system) signal received from a GPS module of the autonomous driving vehicle 200. The server 100 may send the identified current position of the autonomous driving vehicle 200 as a starting point to the transportation company server. The server 100 may send an arrival position corresponding to arrival position information as a destination to the transportation company server to instruct the transportation company vehicle to reach the arrival position.

The transportation company server may search for a transportation company vehicle capable of moving from the current position of the autonomous driving vehicle 200 to the arrival position, and instruct the transportation company vehicle to move to the current position of the autonomous driving vehicle 200. For example, when a taxi managed by the transportation company server is a manned taxi, the transportation company server may provide a driver of the taxi with the current position of the autonomous driving vehicle 200. In contrast, when a taxi managed by the transportation company server is an unmanned taxi, the transportation company server may generate an autonomous travel route from the current position of the taxi to the current position of the autonomous driving vehicle 200, and control the taxi to run along an autonomous travel route.

The autonomous driving vehicle 200 may be a vehicle that drives to its destination without control by the driver. The autonomous driving vehicle may be associated with any artificial intelligence (AI) modules, drones, unmanned aerial vehicles, robots, augmented reality (AR) modules, virtual reality (VR) modules, 5G (5th Generation) mobile communication devices, and the like. Further, the autonomous driving vehicle 200 may be an arbitrary type of vehicle, such as a car, a motorcycle. However, for convenience of description, examples will be described below in which the autonomous driving vehicle 200 is a car.

The autonomous driving vehicle 200 may perform autonomous driving based on a travel route supplied from the server 100. In this regard, the autonomous driving vehicle 200 moves along a lane having the highest lane score among lanes of the road of the travel route. For this purpose, scores may be calculated based on the lanes L1 to Ln of the road.

Further, when a preference mode is selected from the user, the autonomous driving vehicle 200 may move along a lane with the highest preference-based lane score corresponding to the selected preference mode. In this regard, the preference mode may include a ride comfort mode, a fuel consumption mode, a vehicle damage mode, a driving time mode, and the like.

For example, when the user selects a route having a low vehicle damage, that is, the user selects a vehicle damage mode as a preference mode, the autonomous driving vehicle 200 may move along a lane with the highest preference-based lane score corresponding to the vehicle damage mode. In the vehicle damage mode, a lower preference score may be allocated to damaged lanes, temporary lanes, and lanes having high-speed prevention protrusions (e.g., speed bumps).

Thus, the autonomous driving vehicle 200 may avoid a lane having the lowest preference-based lane score corresponding to the selected preference mode, but move along a lane having the highest preference-based lane score corresponding to the selected preference mode. Thus, the autonomous driving vehicle 200 may avoid the damaged lanes, temporary lanes and lanes with high-speed prevention protrusions prior to entering the damaged lanes, temporary lanes and lanes with high-speed prevention protrusions. Thus, the autonomous driving vehicle 200 will have a lower risk of vehicle damage.

Further, when the user selects a route with the lowest fuel consumption, that is, the fuel consumption mode as the preference mode, the autonomous driving vehicle 200 may move along a lane having the highest preference-based lane score corresponding to the fuel consumption mode. For example, in the fuel consumption mode, a lane having a low air flow resistance and a low traffic level has a high preference score. Thus, when the autonomous driving vehicle 200 moves along the lane having low air flow resistance and low traffic level, fuel consumption may be improved (e.g., reduced).

The autonomous driving vehicle 200 can recognize surrounding situation information and road situation information on the road in real-time using sensors such as a radar, lidar and camera mounted on the vehicle via the monitoring system inside the vehicle. In this regard, the surrounding situation information and road situation information may be collected from other autonomous driving vehicles driving around (or near) the autonomous driving vehicle 200 of interest.

The autonomous driving vehicle 200 may upload the recognized surrounding situation information and road situation information to the server 100 in real-time.

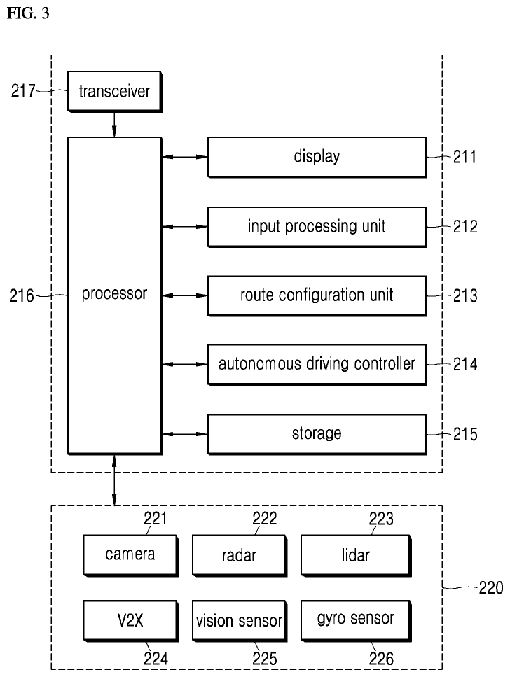

FIG. 3 is a block diagram showing a detailed configuration of a portion of the autonomous driving vehicle according to at least one embodiment.

As shown in FIG. 3, the autonomous driving vehicle 200 may include an internal device 210 and a sensor unit 220.

The internal device 210 is connected to the server 100 via a wireless network and performs data communication with the server. The internal device 210 may perform autonomous driving based on the travel route supplied from the server 100. After determining the driving situation during driving, the internal device 210 may maintain a spacing from a front vehicle, maintain a current lane and change a current lane according to the situation.

To facilitate such operations, the internal device 210 may include a display 211, an input processing unit 212, a route configuration unit 213, an autonomous driving controller 214, a storage (e.g., memory storage) 215, a processor 216, and a transceiver 217.

The sensor unit 220 collects surrounding situation information and road situation information on the road in real-time. The surrounding situation information may include position information of other vehicles and position information of pedestrians existing (or present) on the road. The road situation information may include road-surface state information of a road such as slippery/frozen/damaged states, accident information such as information on an accident occurring on the road, and work section information such as information on a section in which construction or work is being performed.

In this regard, the surrounding situation information and road situation information may be collected from other autonomous driving vehicle(s) driving around (or near) the autonomous driving vehicle 200 of interest.

To facilitate such operations, the sensor unit 220 may include a camera 221, a radar 222, a lidar 223, a V2X (Vehicle-to-Everything) 224, a vision sensor 223, and a gyro sensor 226.

It is understood that the internal device 210 and the sensor unit 220 shown in FIG. 3 are configured according to at least one embodiment. The components thereof are not limited to the embodiment shown in FIG. 3. Some components may be added, changed or deleted as necessary.

The configuration of the internal device 210 and the sensor unit 220 will be described in more detail as follows.

First, the configuration of the internal device 210 according to at least one embodiment will be described in more detail with reference to FIG. 3.

The display 211 may be provided inside the vehicle to display various information relating to autonomous driving to the user on a screen. In this regard, the display 211 may be installed at any position inside the vehicle, and may be embedded in a specific position when the vehicle is manufactured.

The input processing unit 212 may receive an indication input from the user to indicate travel route lookup and selection. In this regard, the input processing unit 212 may be configured as a GUI (Graphical User Interface) such that the input may be input thereto via a user touch on the screen of the display 211. Each GUI 200 may include one or more graphics (or graphics objects) that may represent functionality of a corresponding application.

The input processing unit 212 may be embodied as an HMI (Human Machine Interface) button attached to a cluster, center fascia, vehicle PC, etc. The user may select a preference mode using the input processing unit 212.

The route configuration unit 213 may select a lane having the highest score among the lanes of the road of the route delivered from the server 100.

The autonomous driving controller 214 may perform autonomous driving of the vehicle along the route and lane selected by the route configuration unit 213. In this regard, the autonomous driving controller 214 may have the same (or a similar) configuration as a configuration that performs the autonomous driving in a conventional autonomous driving vehicle. However, a feature of controlling the lane of the travel route of the vehicle based on each lane score of the road or a preference mode of the user may be further provided by the autonomous driving controller 214.

The processor 216 may identify a user's preference mode and road information about a road on which the vehicle is currently driven (or operated). A movement of the vehicle may be determined by the processor 216 based on the identified user's preference mode and road information, and a speed of the vehicle. More specifically, the processor 216 may determine the current movement of the vehicle based on the identified road information and current speed of the vehicle. The movement of the vehicle may be controlled by the processor 216 based on the identified road information and the expected speed of the vehicle.

Further, the processor 216 may display the sensing information collected through (or by) the sensor unit 220 to determine driving information and movement of the vehicle, and each lane score on the display 211, or may store the sensing information and each lane score in a storage 215.

The transceiver 217 transmits the surrounding situation information and the road situation information recognized in real-time to the server 100, and receives routes and lanes selected according to the calculated lane scores from the server 100. Further, the transceiver 217 may perform mutual data communication with the server 100, where the data may include information on an estimated time of arrival at a destination and safety estimated based on a traffic situation of the current route and a traffic situation of a new alternative route.

An operation of the optimal travel route selection device based on the driving situation according to at least one embodiment of the present disclosure configured as described above will be described in more detail with reference to the accompanying drawings. The same reference numerals used in FIG. 2 or FIG. 3 refer to the same member performing the same function in the following drawings.

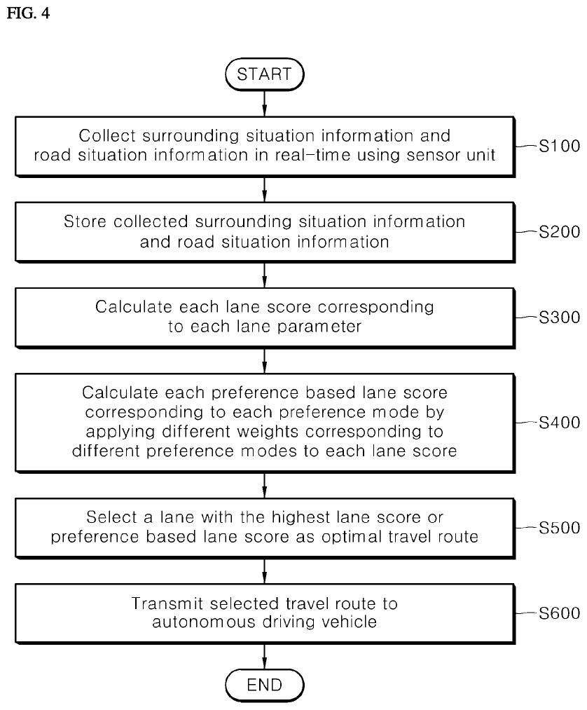

FIG. 4 is a flow chart illustrating an optimal travel route selection method based on a driving situation according to at least one embodiment of the present disclosure.

Referring to FIG. 4, at S100, the autonomous driving vehicle 200 may collect surrounding situation information and road situation information on the road in real-time using the sensor unit 220.

The surrounding situation information may include position information of other vehicles and position information of pedestrians existing (or present) on the road. The road situation information may include road-surface state information of a road such as slippery/frozen/damaged states, accident information such as information on an accident occurring on the road, and work section information such as information on a section in which construction or work is being performed. In this regard, the surrounding situation information and road situation information may be collected from other autonomous driving vehicle(s) driving around (or near) the autonomous driving vehicle 200 of interest. Further, it is understood that the surrounding situation information and the road situation information as collected are not limited thereto.

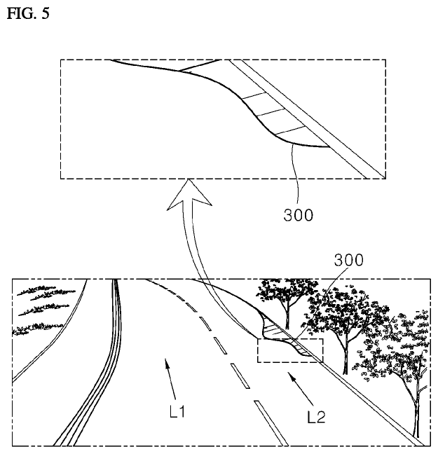

In this regard, at least one embodiment of a process of collecting the surrounding situation information and road situation information (e.g., at S100) will be described with reference to FIGS. 5 to 8.

FIG. 5 illustrates an example of a method for detecting (the presence of) standing water or (the existence of) a frozen state using the sensor unit of FIG. 3 according to at least one embodiment of the present disclosure.

As shown in FIG. 5, the sensor unit 220 may receive an image of each of lanes L1 and L2 of the road during driving using the camera 221, vision sensor 225, and the like, and detect a boundary 300 in the image. Then, the sensor unit 220 may determine the presence of standing water or the existence of a frozen state by comparing the received image with a surrounding image via color contrast, light reflection, or deep neural network (DNN) analysis around the detected boundary line 300. In this regard, the sensor unit 220 may determine which lane L1 or L2 of the road has the presence of standing water or the existence of a frozen state. In FIG. 5, it may be determined that water is accumulated in the second lane L2 or that the frozen state exists in the second lane L2.

The sensor unit 220 may collect motion information of other vehicles that have passed by the target vehicle in the moving direction of the target vehicle using the radar 222, lidar 223, and V2X 224. The sensor unit 220 may detect motion information, such as a horizontal shaking or a bypassing (or swerving) movement at a specific point of each lane L1 or L2, based on the motion information collected from other vehicles. Using such detected information, the sensor unit 220 may determine whether the standing water is present or the frozen state exists on each of lanes L1 and L2.

In this regard, the presence of the standing water or the existence of the frozen state may be determined by the sensor unit 220 using the sensing information. Alternatively, the sensing information detected by the sensor unit 220 in the autonomous driving vehicle 200 may be transmitted to the server 100 which, in turn, may determine whether the standing water is present or the frozen state exists on each of lanes L1 and L2.

In this regard, the server 100 may predict the presence of standing water or the existence of the frozen state via big data analysis based on previously stored road and weather information. For example, when rain or snow falls in a frequently frozen road section within three hours since the vehicle started driving, the server 100 may determine that there is a high possibility that the standing water is present or that the frozen state exists in the frequently frozen road section.

Alternatively, the server 100 receives information transmitted from vehicles that can measure the presence of the standing water or the existence of the frozen state while driving (or operating) on the frequently frozen road section, and determines, based on the received information, whether the standing water is present or the frozen state exists on each lane of the road.

As such, the server 100 may determine whether the standing water is present or the frozen state exists on each of lanes L1 and L2 using the image detected by the sensor unit 220.

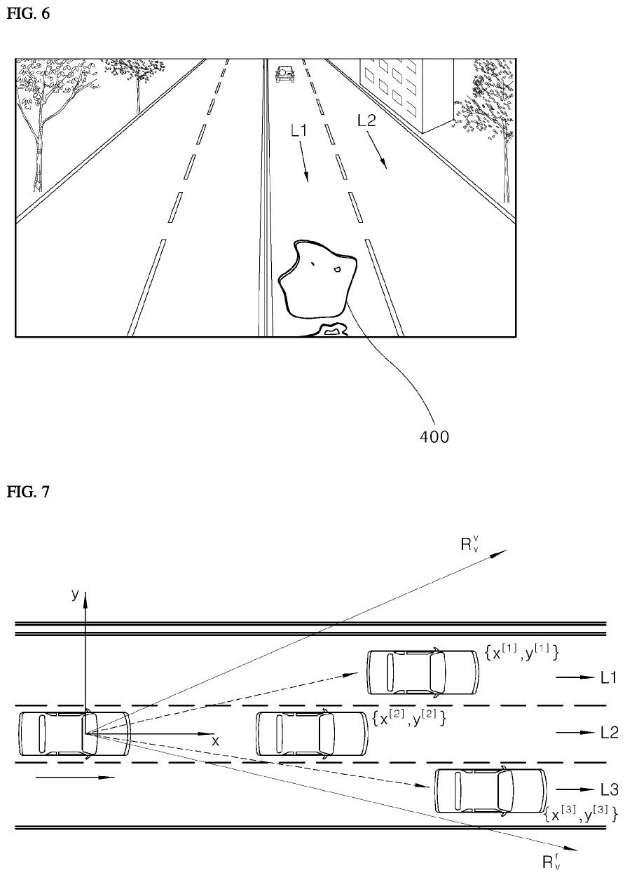

FIG. 6 illustrates an example of a method of detecting (existence of) road wear using the sensor unit of FIG. 3 according to at least one embodiment of the present disclosure.

As shown in FIG. 6, the sensor unit 220 receives the image of each of lanes L1 and L2 of the road during driving using the camera 221, the vision sensor 225, and the like, and detects a boundary line 400 in the image. Then, the sensor unit 220 may determine that road wear has occurred when the detected boundary line 400 is not regular or is discontinuous. In this regard, the sensor unit 220 may determine whether the road wear has occurred by comparison between the received image and the surrounding image via the deep neural network (DNN) analysis of the detected boundary line 400. In this regard, the sensor unit 220 may determine which lane L1 or L2 of the road has the road wear. In FIG. 6, it may be determined that the road wear is positioned (or present) in the first lane L1.

The sensor unit 220 may collect motion information of other vehicles that have passed by the target vehicle in the moving direction of the target vehicle using the radar 222, lidar 223, and V2X 224. The sensor unit 220 may detect motion information, such as a horizontal shaking or a bypassing (or swerving) movement at a specific point of each lane L1 or L2, based on the motion information collected from other vehicles. Using such detected information, the sensor unit 220 may determine whether the road wear is present on each of lanes L1 and L2.

The presence of the road wear may be determined by the sensor unit 220 using the sensing information. Alternatively, the sensing information detected by the sensor unit 220 in the autonomous driving vehicle 200 may be transmitted to the server 100 which, in turn, may determine whether the road wear is present on each of lanes L1 and L2.

FIG. 7 illustrates an example of a method for detecting a position (or location) and a size of a nearby vehicle using the sensor unit of FIG. 3 according to at least one embodiment of the present disclosure.

As shown in FIG. 7, the sensor unit 220 receives an image of lanes L1, L2, and L3 of the road while driving on the road using a camera 221 and a vision sensor 225, and detects a nearby vehicle 500 on each of the lanes L1, L2, and L3. The sensor unit 220 may detect the type and size of the detected nearby vehicle 500. In this regard, the sensor unit 220 may detect the size of the detected vehicle more accurately by detecting distance information between the vehicle of interest and the nearby vehicle additionally using the radar 222 and the lidar 223. The distance between adjacent vehicles may be detected by deriving coordinates of the nearby vehicle 500 positioned within a predefined range of a radar and vision sensor from the vehicle of interest.

In this regard, the sensor unit 220 may detect the type and size of the vehicle via the deep neural network (DNN) analysis based on the image of the detected vehicle.

The sensor unit 220 may receive (information indicating) the accurate type and size of the nearby vehicle from the nearby vehicle using the V2X 224 when the nearby vehicle supports V2X V2V (Vehicle-to-Vehicle).

As such, the sensor unit 220 may determine a type and size of a nearby vehicle on one of lanes L1, L2, and L3 on which the nearby vehicle is present. In FIG. 7, nearby vehicles are positioned on each of the first lane L1, the second lane L2 and the third lane L3. The nearby vehicle positioned on the second lane L2 is closest to the vehicle of interest. The nearby vehicle positioned on the third lane L3 is farthest from the vehicle of interest.

In this regard, the nearby vehicle may be determined by the sensor unit 220 using the sensing information. Alternatively, the sensing information detected by the sensor unit 220 in the autonomous driving vehicle 200 may be transmitted to the server 100 which, in turn, may determine a type and size of a nearby vehicle and one of lanes L1, L2, and L3 on which the nearby vehicle is present.

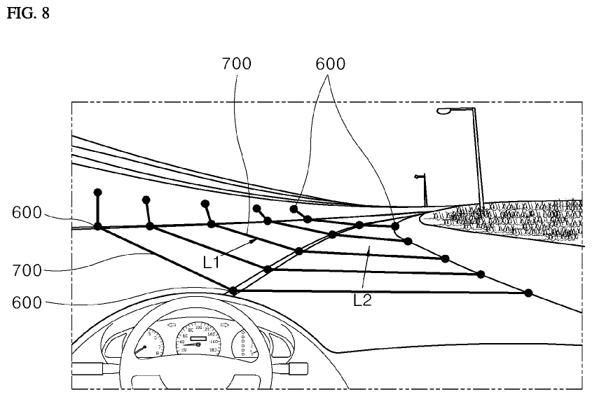

FIG. 8 illustrates an example of a method of detecting inclination of each lane using the sensor unit of FIG. 3 according to at least one embodiment of the present disclosure.

As shown in FIG. 8, the sensor unit 220 receives an image of the road using a camera 221, a vision sensor 225, and the like, and detects lanes L1 and L2. Then, the sensor unit 220 generates points 600 spaced uniformly along parallel lines on each detected lane L1 and L2. Then, the sensor unit 220 may create a connection line 700 connecting points in a transverse direction and detect an inclination of each lane L1 and L2 using a slope value of each connection line.

In this regard, the sensor unit 220 may detect the inclination of each of lanes L1 and L2 via the deep neural network (DNN) analysis based on the image of the road.

The sensor unit 220 receives position information (e.g., x, y, yaw/roll/pitch angle information) of raw data (point cloud) using the radar 222 and lidar 223, and detects the inclination of each of lanes L1 and L2 (or high-speed prevention protrusion thereof). Further, the sensor unit 220 may detect the inclination of each lane of a road of the current driving route using an angular velocity value of each of the three axes (yaw/roll/pitch axes) as measured using the gyro sensor 226.

In this regard, the inclination of each lane L1 and L2 may be detected by the sensor unit 220 using the sensing information. Alternatively, the sensing information detected by the sensor unit 220 of the autonomous driving vehicle 200 may be passed to the server 100 which, in turn, may detect the inclination of each lane of a road. Alternatively, when the nearby vehicle can measure the inclination of each lane while moving on each lane, the server 100 may receive the measured inclination and thus detect the inclination of each lane.

As shown in FIG. 5 to FIG. 8, the sensor unit 220 may collect and determine the surrounding situation information and road situation information for each lane of the road of the route that the autonomous driving vehicle 200 of interest is currently driving on. In this regard, the surrounding situation information and road situation information for each lane may be determined by the sensor unit 220 of the autonomous driving vehicle 200. Alternatively, the sensing information input from the autonomous driving vehicle 200 may be transmitted to the server 100 which, in turn, may determine the surrounding situation information and road situation information for each lane.

Referring back to FIG. 4, the server 100 receives and stores therein the surrounding situation information and road situation information which may cause a change in driving environment from a plurality of autonomous driving vehicles 200. In this regard, the server 100 may store therein weather and traffic information together with the surrounding situation information and road situation information and/or may store the same in the cloud.

Then, server 100 calculates each lane score corresponding to each lane parameter derived based on the stored surrounding situation information and road situation information at S300. In this regard, server 100 may use the surrounding situation information and road situation information as parameters. Then, the server 100 calculates a score for each lane using each parameter. In this regard, each lane score may be calculated further based on weather information and traffic information as parameters.

For example, referring back to FIG. 5, the server 100 does not detect the presence of standing water or the existence of the frozen state in the first lane 1 L1 of the road, and detects the standing water is present or the frozen state exists in the second lane L2 of the road. Therefore, the server 100 may allocate a higher score to the first lane L1 and a lower score to the second lane L2. Further, referring to FIG. 6, the server 100 detects the presence of road wear on the first lane L1 of the road and does not detect the presence of road wear in the second lane L2 of the road. Therefore, the server 100 allocates a lower score to the first lane L1, and allocates a higher score to the second lane L2.

In this regard, a procedure for configuring the score is described in more detail below.

According to at least one embodiment, each parameter is normalized in a range of 1 to 100 so that each lane score calculated based on each parameter does not exceed 100. This may lead to a result in which all lane scores calculated based on the parameters for all lanes have a same first weight. That is, when the presence of standing water and/or the existence of the frozen state are detected in the first lane L1 while the presence of road wear is detected in the second lane L2, two lane scores for the lanes L1 and L2 may be calculated using the same first weight.

A method for calculating the score for each lane is described in more detail as follows with respect to at least one embodiment.

In one example, parameters are limited to those regarding standing water, frozen state, road wear, nearby vehicles, and inclination. However, embodiments of the present disclosure may not be limited thereto. The server 100 may calculate each lane score based on a parameter such as the presence of standing water or the existence of the frozen state using a slippage and a section length as a condition value.

In this regard, the condition value may be used for determining the standing water and frozen state levels. The slippage is related to the number of wheels that are rubbing at the same time. The section length is related to a duration in which each of one or more wheels is rubbing. The condition value is merely one example, and embodiments of the present disclosure are not limited thereto.

In one example, the greater the slippage among the condition values, the greater the level of standing water or frozen state. The larger the section length among the condition values, the greater the level of standing water or frozen state.

Then, the slippage may be calculated as the number of wheels (among 4 wheels) that are rubbing at the same time*10. Further, the section length may be calculated as a duration (sec) in which each of one or more wheels are rubbing*10.

Then, each lane score based on the parameter of the standing water or frozen state level is calculated as a sum of the condition values calculated for each lane. In this regard, the sum of all condition values does not exceed 100. As such, the slippage may be defined as a condition value in a range of 1 to 40. The section length may be defined as a condition value in a range 1 to 60. However, embodiments of the present disclosure are not limited thereto.

Further, the server 100 may calculate each lane score based on the parameter of the road wear level using a degree of wear of the road and the section length as the condition values.

In this regard, the condition value may be used for determining the level of road wear. The wear level of the road may be related to the up and down (or vertical) vibration magnitude of the vehicle. That is, when the wear level of the road is very serious, the up and down vibration magnitude of the vehicle may be higher. When the wear level of the road is negligible, the up and down vibration magnitude of the vehicle may be lower. In this regard, the condition values corresponding to the up and down vibration magnitude of the vehicle may be stored in a table in advance. The condition value described is merely one example. Embodiments of the present disclosure are not limited thereto.

In one example, the greater the degree of wear of the road among the condition values, the greater the level of road wear and thus the greater the up and down vibration magnitude of the vehicle. The greater the section length among the condition values, the greater the level of road wear.

The wear level of the road may correspond to the vibration magnitude of the vehicle and may pre-stored in a table as the condition value, and thus may be retrieved from the table. Further, when the degree of wear of the road is defined within a range of 1 to 100, the section length may be calculated as 10*a duration (sec) in which the wear of the road exceeding (e.g., a value of) 10 continues.

Then, each lane score based on the parameter of the degree of wear of the road is calculated as the sum of the condition values calculated for each lane. In this regard, the sum of all condition values does not exceed 100. For example, the degree of the road wear may be defined in the range of 1 to 40. The section length may be defined in the range 1 to 60. However, embodiments of the present disclosure are not limited thereto.

Further, the server 100 may calculate each lane score based on parameters including the position and size of the nearby vehicle, and using the size of the nearby vehicle, the same route driving distance, and times of lane switching of the vehicle of interest as the condition values.

In this regard, the condition value may be used for determining the position and size of a nearby vehicle. The nearby vehicle size may be a nearby vehicle measurement result from a sensor in the vehicle of interest or may be size information of the nearby vehicle obtained via V2V. The same route driving distance refers to route distance information of the nearby vehicle and the vehicle of interest as obtained by V2V. Further, the times of lane switching of the vehicle of interest may refer to information about the number of times the vehicle of interest switches from one lane to another along the route from a current position to an arrival position. In this regard, the condition values are not limited thereto because the condition level described is merely one example.

In one example, the larger the size of the nearby vehicle, the greater the level of position and size of the nearby vehicle. The longer the same route driving distance among the condition values, the greater the level of position and size of the nearby vehicle. Further, the fewer the times of lane switching among the condition values, the greater the level of the position and size of the nearby vehicle.

Then, the size of the nearby vehicle may be calculated to have a larger value when the detected nearby vehicle is larger. Further, the same route driving distance may be calculated to have a larger value when a difference between the route distance of the nearby vehicle and the route distance of the vehicle of interest as obtained via V2V is smaller. Further, the lane switching count may be calculated as the number of times the vehicle of interest switches from one lane to another along the route from the current position to the arrival position.

Then, each lane score based on the parameter of the position and size of the nearby vehicle may be calculated as the sum of the condition values calculated for each lane. In this regard, the sum of all condition values does not exceed 100. For example, the size of the nearby vehicle as the condition value may be defined in a range of 1 to 40. The same route driving distance may be defined as a condition value in a range of 1 to 30. Further, the lane switching count is defined as a condition value in a range of 1 to 30. However, embodiments of the present disclosure are not limited thereto.

Further, the server 100 may calculate each lane score based on the parameter of inclination (longitudinal/transverse inclinations) using a longitudinal inclination and a transverse inclination as condition values.

In this regard, the condition value may be used to determine the level of inclination of each lane. The longitudinal inclination level may be related to a longitudinal inclination of each lane on which the vehicle is currently driving. The transverse inclination level may be related to the transverse inclination of each lane on which the vehicle is currently driving (or operating).

In one example, the greater the longitudinal inclination and transverse inclination as the condition values, the greater the inclination level of each lane.

Then, the longitudinal inclination level may be calculated as the longitudinal inclination*1. Further, the transverse inclination level may be calculated as the transverse inclination*2.

Then, each lane score based on the parameter of the inclination may be calculated as the sum of condition values calculated for each lane. In this regard, the sum of all condition values does not exceed 100. For example, the longitudinal inclination level may be defined as a condition value in a range of 1 to 20, while the transverse inclination level as a condition value may be defined in a range of 1 to 80.

In one example, the server 100 calculates each preference based lane score by applying different weights corresponding to different user preference modes to each calculated lane score. In this regard, the preference mode may include a ride comfort mode, fuel consumption mode, vehicle damage mode, driving time mode, and the like. Thus, the user's preferred mode may be selected.

In this regard, a method to calculate each preference based lane score is described in more detail as follows with respect to at least one embodiment:

With reference to FIG. 4, the server 100 may calculate each preference based lane score corresponding to each preference mode by applying a second weight corresponding to each preference mode to each calculated lane score at S400. That is, different second weights corresponding to different preference modes may be applied to each lane score based on each parameter.

In one example, the parameters used for calculating each lane score may include the standing water or frozen state (A), the road wear (B), the nearby vehicle (C), the inclination (D), and a current route maintenance (E). Then, a second weight (A′) may be applied to the standing water or frozen state (A), a second weight (B′) may be applied to the road wear (B). A second weight (C′) may be applied to the nearby vehicle (C). A second weight (D′) may be applied to the inclination (D). A second weight (E′) may be applied to the current route maintenance (E).

In this regard, the second weights A′, B′, C′, and D′ as applied to the parameters A, B, C, and D may be different from each other based on influence thereof on the preference mode.

As shown in Table 1, the second weight applied to a specific preference mode may be higher as the influence thereof on the specific preference mode increases. The second weight applied to a specific preference mode may be lower as the influence thereof on the specific preference mode decreases. In this regard, it should be noted that the second weight applied to the specific preference mode may be changed by a user. Further, a sum of all of the second weights to be applied to the specific preference mode may be 1.

In one example, the autonomous driving vehicle 200 has decreased ride comfort and increased (risk of) vehicle damage as the autonomous driving vehicle 200 moves along a road with the standing water or frozen state or road wear among the parameters. Further, the autonomous driving vehicle 200 may reduce the resistance of the air flow to decrease the fuel consumption when driving in rear of (or behind) a larger nearby vehicle among the parameters. Further, when assuming that the autonomous driving vehicle 200 moves along the same route, the autonomous driving vehicle 200 may arrive at its destination as quickly as possible when keeping the same lane without changing lanes.

As such, as in Table 1, the second weights may be determined depending on the effects thereof on a corresponding preference mode.

TABLE 1

| Preference mode | Second weight |
|---|---|
| Ride comfort | A′ −> 0.3 |
| | B′ −> 0.4 |
| | C′ −> 0.1 |
| | D′ −> 0.1 |
| | E′ −> 0.1 |
| Fuel consumption | A′ −> 0.1 |
| | B′ −> 0.3 |
| | C′ −> 0.4 |
| | D′ −> 0.1 |
| | E′ −> 0.1 |
| Vehicle damage | A′ −> 0.3 |
| | B′ −> 0.4 |
| | C′ −> 0.1 |
| | D′ −> 0.1 |
| | E′ −> 0.1 |
| Driving time duration | A′ −> 0.1 |
| | B′ −> 0.1 |
| | C′ −> 0.1 |
| | D′ −> 0.1 |
| | E′ −> 0.6 |

In one example, the server 100 may calculate each lane score at regular intervals. Further, the server 100 may calculate each lane score for three cases, that is, a case when keeping a current driving lane, a case when switching to a left lane with respect to the current lane and a case when switching to a right lane with respect to the current lane.

For example, the server 100 calculates each lane score using a parameter related to the current lane while the vehicle is driving (or being driven). Then, the server 100 calculates each lane score using a parameter related to a left lane with respect to the current lane while the vehicle is driving. Further, the server 100 calculates each lane score using a parameter related to a right lane with respect to the current lane while the vehicle is driving.

Thus, according to at least one embodiment, even when there are at least three lanes on a currently driven road, the server 100 calculates the lane score for only three lanes.

Then, the server 100 configures a lane with the highest lane score or preference based lane score as an optimal travel route at S500. In this regard, when the user does not select a separate preference mode, the server 100 may select a lane with the highest lane score as an optimal route. Further, when a separate preference mode is selected from the user, the server 100 may select a lane with the highest preference-based lane score corresponding to the selected preference mode as the optimal travel route.

Subsequently, at S600, the server 100 transmits (information regarding) a travel route corresponding to a current position and a destination of the autonomous driving vehicle 200 to the autonomous driving vehicle 200 using the GPS information of the autonomous driving vehicle 200 based on the configured travel route.

The autonomous driving vehicle 200 may perform the autonomous driving based on the travel routes supplied from the server 100. In this regard, the autonomous driving vehicle 200 may move along a lane with the highest lane score when no preference mode is selected from the user.

Further, when a separate preference mode is selected from the user, the autonomous driving vehicle 200 may move along a lane with the highest preference-based lane score corresponding to the selected preference mode. In this regard, the preference mode may include a ride comfort mode, a fuel consumption mode, a vehicle damage mode, a driving time mode, and the like.

For example, when the user selects a route having a low vehicle damage, that is, the user selects a vehicle damage mode, the autonomous driving vehicle 200 may move along a lane with the highest preference-based lane score corresponding to the vehicle damage mode. In the vehicle damage mode, a lower preference score may be allocated to damaged lanes, temporary lanes, and lanes with high-speed prevention protrusions (e.g., speed bumps).

Thus, the autonomous driving vehicle 200 may avoid a lane with the lowest preference-based lane score corresponding to the selected preference mode, but move along a lane with the highest preference-based lane score corresponding to the selected preference mode. Thus, the autonomous driving vehicle 200 may avoid the damaged lanes, temporary lanes and lanes with high-speed prevention protrusions prior to entering the damaged lanes, temporary lanes and lanes with high-speed prevention protrusions. Thus, it is expected that the autonomous driving vehicle 2200 will have lowered (risk of) vehicle damage.

Further, when the user selects a route with the lowest fuel consumption, that is, the user selects the fuel consumption mode, the autonomous driving vehicle 200 may move along a lane with the highest preference-based lane score corresponding to the fuel consumption mode. In other words, in the fuel consumption mode, a lane with low air flow resistance and low traffic level has a high preference score. Thus, when the autonomous driving vehicle 200 moves along the lane with low air flow resistance and low traffic level, this may help improve (e.g., reduce) the fuel consumption.

In one example, the autonomous driving vehicle may be connected to any artificial intelligence (AI) modules, drones, unmanned aerial vehicles, robots, augmented reality (AR) modules, virtual reality (VR) modules, 5G (5th Generation) mobile communication devices, and the like.

Artificial intelligence refers to a field of researching artificial intelligence or methodologies that can produce the AI. Machine Learning refers to a field of researching methodologies that define and solve various problems involved in the field of artificial intelligence. Machine learning is defined as an algorithm that improves performance of a task via a consistent experience with that task.

Artificial Neural Network (ANN) refers to a model used in machine learning. ANN may refer to a whole problem-solving model composed of artificial neurons (nodes) forming a synaptic network. The artificial neural network may be defined by a connection pattern between neurons of different layers, a learning process for updating model parameters, and an activation function for generating an output value.

The artificial neural network may include an input layer, an output layer, and, optionally, one or more hidden layers. Each layer contains one or more neurons. The artificial neural network may include synapses that connect neurons to neurons. In the artificial neural network, each neuron may output a function value of an activation function for input signals, weights, and biases input through the synapses.

The model parameter refers to a parameter that is determined via learning and includes a weight of synaptic connections and the bias of neurons. A hyperparameter refers to a parameter that must be configured before learning in the machine learning algorithm. The hyperparameter may include a learning rate, the number of iterations, a mini batch size, and an initialization function.

A purpose of training the artificial neural networks may be viewed as determining a model parameter that minimizes a loss function. The loss function may be used as an index for determining an optimal model parameter in the training process of the artificial neural network.

Machine learning may be classified into supervised learning, unsupervised learning, and reinforcement learning.

Supervised learning refers to a method that trains an artificial neural network in a state in which a label is allocated to training data. The label may refer to a correct answer or result value that the artificial neural network should infer when the training data is input to the artificial neural network. Non-supervised learning may refer to a method for training the artificial neural network in a state in which a label is not allocated to training data. Reinforcement learning may refer to a method that allows an agent defined in a certain environment to be trained to select an action or sequence of actions that maximizes a cumulative reward in each state.

Machine learning implemented by a deep neural network (DNN) including a plurality of hidden layers among the artificial neural networks is also called deep learning. Deep learning is a part of machine learning. In the following description, the machine learning may include the deep learning.

A robot may refer to a machine that automatically (or autonomously) handles a given task by its own capabilities or operates automatically (or autonomously). In particular, a robot having a function of performing an operation while recognizing an environment and determining the environment by itself may be referred to as an intelligent robot.

The robot may be classified into industrial, medical, household, military, etc. robots according to their purpose or field of use.

The robot may include a driving unit including an actuator or a motor to perform various physical operations such as moving a robotic joint. Further, a movable robot may include wheels, a brake and a propeller in a drive unit, and can drive on a ground or fly in the air via the drive unit.

Autonomous driving refers to a technology in which a vehicle drives by itself Δn autonomous driving vehicle refers to a vehicle that drives without the user's manipulation or with minimal user manipulation.

For example, autonomous driving may include a technology of maintaining a driving lane, a technology of automatically adjusting a speed such as adaptive cruise control, a technology of automatically driving along a predetermined route, and a technology of automatically configuring a route when a destination is set.

The vehicle includes a vehicle having only an internal combustion engine, a hybrid vehicle having an internal combustion engine and an electric motor together, and an electric vehicle having only an electric motor. The vehicle may include trains, motorcycles, etc. as well as cars.

In this regard, the autonomous driving vehicle may be considered as a robot with autonomous driving features (or functionality).

Extended reality (XR) collectively refers to Virtual Reality (VR), Augmented Reality (AR), and Mixed Reality (MR). VR technology provides real world objects and backgrounds only using a CG (computer graphics) image. AR technology overlaps a CG image created virtually on a real object image. MR technology refers to a computer graphics technology that mixes and combines virtual objects with the real world.

MR technology is similar to AR technology in that MR shows both real and virtual objects. However, in AR technology, virtual objects are used to complement real objects, while in MR technology, virtual objects and real objects are used for the same purpose.

XR technology may be applied to HMD (Head-Mount Display), HUD (Head-Up Display), mobile phone, tablet PC, laptop, desktop, TV, digital signage, etc. A device to which XR technology is applied may be referred to as an XR device.

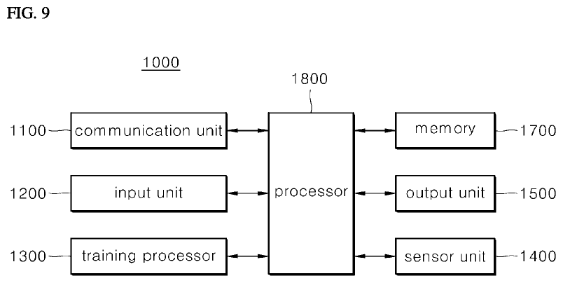

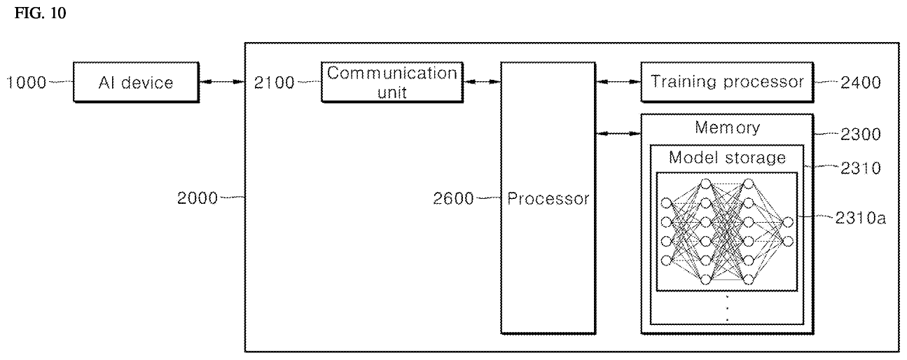

FIG. 9 is a block diagram of an AI device according to at least one embodiment of the present disclosure. FIG. 10 is a block diagram of an AI server according to at least one embodiment of the present disclosure.

Referring to FIG. 9 and FIG. 10, an AI device 1000 may be embodied as a TV, projector, mobile phone, smartphone, desktop computer, laptop, digital broadcasting terminal, PDA (personal digital assistant), PMP (portable multimedia player), navigation, tablet PC, wearable device, set top box (STB), DMB (digital multimedia broadcasting) receiver, radio, washing machine, refrigerator, a digital signage, a robot, a vehicle, or the like. That is, the AI device 1000 may be implemented as a fixed device or a movable device,

Referring to FIG. 9, the AI device 1000 may include a communication unit 1100, an input unit 1200, a training processor 1300, a sensor unit 1400, an output unit 1500, a memory 1700, a processor 1800, and the like.

The communication unit 1100 may transmit/receive data to and from external devices such as other AI devices or an AI server using wired or wireless communication technology. For example, the communication unit 1100 may transmit/receive sensor information, a user input, a learning model, a control signal, and the like to and from the external devices.

In this regard, the communication unit 1100 may use GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Communication Infrared Data Association (IrDA), ZigBee and NFC (Near Field Communication), etc.

The input unit 1200 may acquire various kinds of data.

In this regard, the input unit 1200 may include a camera for inputting an image signal, a microphone for receiving an audio signal, a user input unit for receiving information from a user, and the like. In this regard, the camera or microphone may be considered as a sensor, and a signal obtained from the camera or microphone may be referred to as sensing data or sensor information.

The input unit 1200 may obtain input data to be used when obtaining output from a learning model using training data for training the learning model. The input unit 1200 may acquire raw input data. In this case, the processor 1800 or training processor 1300 may extract an input feature resulting from preprocessing of the input data.

The training processor 1300 may train a model composed of an artificial neural network using the training data. In this regard, a trained artificial neural network may be referred to as a learning model. The learning model may be used to infer result values for new input data rather than the training data. The inferred value may be used as a basis for determining what operation is to be performed.

In this regard, the training processor 1300 may perform the AI processing together with a training processor 2400 of the AI server 2000 (see, e.g., FIG. 10).

In this regard, the training processor 1300 may include memory integrated or implemented in the AI device 1000. Alternatively, the training processor 1300 may be implemented using a memory 1700, an external memory directly coupled to the AI device 1000, or a memory maintained in an external device.

The sensor unit 1400 may obtain at least one of internal information inside the AI device 1000, surrounding environment information around the AI device 1000, or user information of the AI device 1000 using various sensors.

In this regard, the sensors included in the sensor unit 1400 may include a proximity sensor, luminance sensor, acceleration sensor, magnetic sensor, gyro sensor, inertial sensor, RGB (red, green and blue) sensor, IR (infrared) sensor, fingerprint sensor, ultrasonic sensor, optical sensor, microphone, lidar, radar, etc.

The output unit 1500 may generate a haptic, audio or visual output.

In this regard, the output unit 1500 may include a display for outputting visual information, a speaker for outputting auditory information, and a haptic module for outputting tactile information.

The memory 1700 may store data supporting various functions of the AI device 1000. For example, the memory 1700 may store input data acquired from the input unit 1200, training data, learning model, learning history, and the like.

The processor 1800 may determine at least one executable operation of the AI device 1000 based on information determined or generated using a data analysis algorithm or a machine learning algorithm. Then, the processor 1800 may control components of the AI device 1000 to perform the determined operation.

To this end, the processor 1800 may control at least one component of the AI device 1000 to request, retrieve, receive or utilize data of the training processor 1300 or memory 1700, or to execute a predicted or desirable operation among the at least one executable operation.

In this regard, when the processor 1800 needs to connect to an external device to perform the determined operation, the processor 1800 may generate a control signal to control the external device. Then, the generated control signal may be transmitted to the external device.

The processor 1800 may obtain intent (or intention) information about the user input. Then, requirements of the user may be determined by the processor 1800 based on the obtained intention information.

In this regard, the processor 1800 may use at least one of a STT (Speech To Text) engine to convert voice input into a character string or a natural language processing (NLP) engine to obtain intent information in a natural language, to obtain intent information corresponding to the user input.

In this regard, at least one of the STT engine or NLP engine may be composed of an artificial neural network, at least a portion of which is trained according to a machine learning algorithm. At least one of the STT engine or the NLP engine may be trained by the training processor 1300, may be trained by the training processor 2400 of the AI server 2000, or may be trained by their distributed processing.

The processor 1800 may collect historical information including operation contents of the AI device 1000 or user feedback about the operation, and store the information in the memory 1700 or the training processor 1300, or transmit the information to an external device such as an AI server 2000. The collected historical information may be used to update the learning model.

The processor 1800 may control at least some components of the AI device 1000 to execute an application stored in the memory 1700. Further, the processor 1800 may operate a combination of two or more of the components included in the AI device 1000 to execute the application program.

Referring to FIG. 9 and FIG. 10, the AI server 2000 may refer to a device that trains an artificial neural network using a machine learning algorithm or uses the trained artificial neural network. In this regard, the AI server 2000 may be composed of multiple servers to perform distributed processing or may be configured using a 5G network. In this regard, the AI server 2000 is included as a part of the AI device 1000 and may perform at least a portion of the AI processing together with the AI device 1000.

The AI server 2000 may include a communication unit 2100, a memory 2300, a training processor 2400, a processor 2600, and the like.

The communication unit 2100 may exchange data with an external device such as an AI device 1000.

The memory 2300 may include a model storage 2310. The model storage 2310 may store a model (or an artificial neural network 2310a) that is being trained or has been trained by the training processor 2400.

The training processor 2400 may train the artificial neural network 2310a using training data. The learning model may be used while mounted in the AI server 2000 of an artificial neural network, or may be used while mounted in an external device such as an AI device 1000.

The learning model may be implemented in hardware, software or a combination of hardware and software. When a portion or an entirety of the learning model is implemented in software, one or more instructions constituting the learning model may be stored in the memory 2300.

The processor 2600 may infer a result value for new input data using the learning model, and may generate a response or control command based on the inferred result.

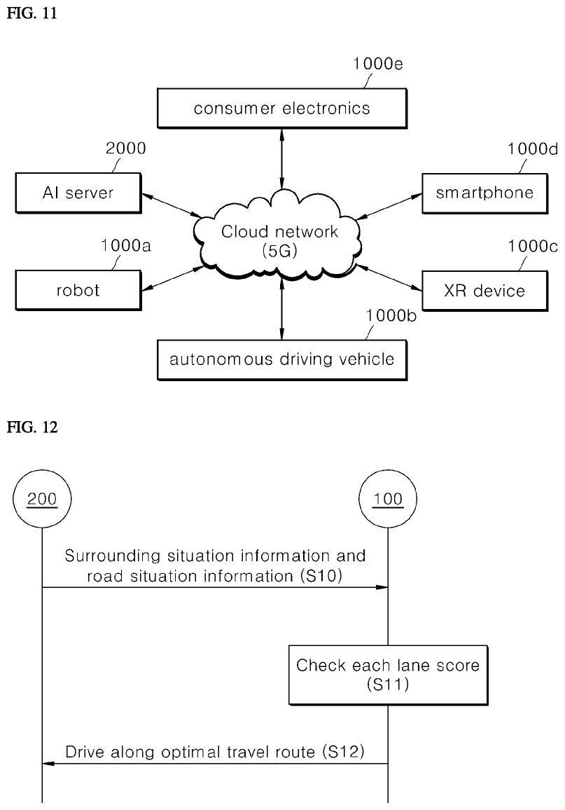

FIG. 11 is a block diagram of an AI system according to at least one embodiment of the present disclosure.

Referring to FIG. 11, at least one of an AI server 2000, robot 1000a, autonomous driving vehicle 1000b, XR device 1000c, smartphone 1000d or consumer electronics (e.g., home appliance) 1000e of the AI system is connected to a cloud network. In this regard, the robot 1000a, the autonomous driving vehicle 1000b, the XR device 1000c, the smartphone 1000d, or the home appliance 1000e to which AI technology is applied may be referred to as AI devices 1000a to 1000e.

The cloud network may refer to a network that constitutes a portion of a cloud computing infrastructure or exists within a cloud computing infrastructure. In this regard, the cloud network may be configured using 3G network, 4G or LTE Long (Term Evolution network) or 5G network or the like.

That is, the devices 1000a to 1000e and 2000 constituting the AI system may be connected to each other via the cloud network. In particular, the devices 1000a to 1000e and 2000 may communicate with each other via a base station, or may communicate with each other directly without using the base station.

The AI server 2000 may include a server that performs AI processing and a server that performs operations on big data.

The AI server 2000 is connected to at least one or more of the AI devices constituting the AI system, such as the robot 1000a, autonomous driving vehicle 1000b, XR device 1000c, smartphone 1000d or consumer electronics 1000e over the cloud network. The AI server 2000 may help with at least a portion of the AI processing of the connected AI devices 1000a to 1000e.

In this regard, the AI server 2000 may train the artificial neural network using the machine learning algorithm on behalf of the connected AI devices 1000a to 1000e. Then, the learning model may be stored directly in the AI server 2000 or transmitted therefrom to the connected AI devices 1000a to 1000e.

In this regard, the AI server 2000 may receive input data from the connected AI devices 1000a to 1000e, and may infer a result value for the received input data using the learning model. Then, a response or a control command may be generated by the AI server 2000 based on the inferred result and then may be transmitted therefrom to the connected AI devices 1000a to 1000e.

Alternatively, the connected AI devices 1000a to 1000e may directly infer result values from the input data using the learning model, and then may generate a response or control command based on the inferred result.

Hereinafter, various embodiments of the AI devices 1000a to 1000e to which the above-described technology is applied will be described. In this regard, the AI devices 1000a to 1000e as illustrated in FIG. 11 may be viewed as specific embodiments of the AI device 1000 as illustrated in FIG. 9.

In one example, the robot 1000a may have an AI function and be implemented as a guide robot, a transport robot, a cleaning robot, a wearable robot, an entertainment robot, a pet robot, an unmanned flying robot, or the like.

The robot 1000a may include a robot control module for controlling motion of the robot. The robot control module may refer to a software module or a chip implemented in hardware.

The robot 1000a acquires state information of the robot 1000a using sensor information obtained from various kinds of sensors, detects and recognizes the surrounding environment and objects, generates map data, determines a travel route and driving plan, or determines a response to a user interaction or determines an action.

In this regard, the robot 1000a may use sensor information obtained from at least one sensor among a lidar, a radar, and a camera to determine a travel route and a driving plan.

The robot 1000a may perform the above operations using a learning model composed of at least one artificial neural network. For example, the robot 1000a may recognize a surrounding environment and object using a learning model. Then, the robot 1000a may determine an operation to be performed based on the recognized surrounding environment information or object information using the learning model. In this regard, the learning model may be trained directly by the robot 1000a or by an external device such as the AI server 2000.

In this regard, the robot 1000a may directly generate a result using the learning model to perform the operation. Alternatively, the robot 1000a may send the sensor information to an external device such as the AI server 2000 and receive a result using the learning model therefrom.

The robot 1000a determines a travel route and a driving plan using at least one of map data, object data detected from the sensor information, or object information obtained from an external device. The robot 1000a may control the driver unit to drive the robot according to the travel route and the driving plan as determined.

The map data may include object identification information about various objects arranged in a space where the robot 1000a moves. For example, the map data may include object identification information about fixed objects such as walls and doors and movable objects such as flower-pots and desks. Then, the object identification information may include name, type, distance, position, and the like.

Further, the robot 1000a may perform an operation or drive by controlling the driver unit based on the control/interaction of and from the user. In this regard, the robot 1000a obtains intention information about interaction according to the user's action or voice (or vocal) utterance. Then, a response thereto may be determined by the robot 1000a based on the acquired intention information. Then, the robot 1000a may perform an operation based on the response.

In one example, the autonomous driving vehicle 1000b may have AI technology applied thereto, and may be implemented as a mobile robot, a vehicle, an unmanned aerial vehicle, etc.

The autonomous driving vehicle 1000b may include an autonomous driving control module for controlling the autonomous driving function. The autonomous driving control module may refer to a software module or a chip implemented in hardware. The autonomous driving control module may be included as an internal component of the autonomous driving vehicle 1000b, or may be embodied as separate hardware external to the autonomous driving vehicle 1000b and may be connected thereto.

The autonomous driving vehicle 1000b acquires state information of the autonomous driving vehicle 1000b using sensor information obtained from various types of sensors. Further, the autonomous driving vehicle 1000b may detect or recognize surrounding environment and objects, generate map data, determine a travel route and driving plan, or determine an operation, based on the sensor information obtained from various types of sensors.

In this regard, like the robot 1000a, the autonomous driving vehicle 1000b may use sensor information obtained from at least one sensor among the lidar, radar, or camera, to determine a travel route and a driving plan.

In particular, the autonomous driving vehicle 1000b may recognize an environment or an object in an area where a field of view is obscured or an area over a certain distance using received sensor information from external devices. Alternatively, the autonomous driving vehicle 1000b may directly receive, from the external devices, (information relating to) an environment or an object in an area where a field of view is obscured or an area over a certain distance using received sensor information from external devices.

The autonomous driving vehicle 1000b may perform the above mentioned operations using a learning model composed of at least one artificial neural network. For example, the autonomous driving vehicle 1000b may recognize a surrounding environment and object using a learning model. A driving line may be determined by the autonomous driving vehicle 1000b based on the recognized surrounding environment information or object information. In this regard, the learning model may be trained directly by the autonomous driving vehicle 1000b or by an external device such as the AI server 2000.

In this regard, the autonomous driving vehicle 1000b may directly use the learning model to generate the result and perform one or more actions based on the result. Alternatively, the autonomous driving vehicle 1000b may transmit the sensor information to an external device such as the AI server 2000 and may receive a result generated accordingly using a learning model in the server therefrom.

The autonomous driving vehicle 1000b may determine a travel route and a driving plan using at least one or more of map data, object data detected from the sensor information, or object information obtained from the external device. The autonomous driving vehicle 1000b may control the driving unit to drive the vehicle according to the travel route and the driving plan as determined.

The map data may include object identification information about various objects arranged in a space, for example, a road on which the autonomous driving vehicle 1000b is operating. For example, the map data may include object identification information about fixed objects such as street-lights, rocks, and buildings, and movable objects such as vehicles and pedestrians. Then, the object identification information may include name, type, distance, position, and the like.

Further, the autonomous driving vehicle 1000b may perform an operation or may drive by controlling the driving unit based on control/interaction of and with the user. In this regard, the autonomous driving vehicle 100b acquires intention information about interaction according to the user's motion or voice (or vocal) utterance. Then, a response thereto may be determined by the vehicle 1000b based on the acquired intention information. Then, the vehicle 1000b may perform an operation based on the response.

In one example, the XR device 1000c may have AI technology applied thereto, and may be embodied as HMD (Head-Mount Display), or HUD (Head-Up Display) mounted in a vehicle, television, mobile phone, smartphone, computer, wearable device, home appliance, digital signage, a vehicle, a fixed robot or a mobile robot.

The XR device 1000c may analyze 3D point cloud data or image data obtained through various sensors or from an external device to generate position data and attribute data about 3D points, to acquire information about a surrounding space or real object and to render and output an XR object. For example, the XR device 1000c may output an XR object including additional information about the recognized object to be overlapped with the recognized object.

The XR device 1000c may perform the above mentioned operations using a learning model composed of at least one artificial neural network. For example, the XR device 1000c may recognize a real object from 3D point cloud data or image data using a learning model, and may provide information corresponding to the recognized real object. In this regard, the learning model may be trained directly by the XR device 1000c or by an external device such as the AI server 2000.

In this regard, the XR device 1000c may directly generate a result using a learning model and may perform an operation based on the result. Alternatively, the XR device 1000c may transmit sensor information to an external device such as the AI server 2000 and may receive a result produced using a learning model in the AI server therefrom.

In one example, the robot 1000a may have the AI technology and autonomous driving technology applied thereto and may be implemented as a guide robot, a transport robot, a cleaning robot, a wearable robot, an entertainment robot, a pet robot, an unmanned flying robot, etc.

The robot 1000a having the AI technology and the autonomous driving technology applied thereto may refer to a robot itself with the autonomous driving function (or feature) or the robot 1000a interacting with the autonomous driving vehicle 1000b.

The robot 1000a with the autonomous driving function may collectively refer to devices each of which moves by itself according to a given moving line without user control, or which determines the moving line by itself and moves by itself according to the moving line without user control.

The robot 1000a and autonomous driving vehicle 1000b with autonomous driving may use a common sensing method to determine one or more of a travel route or driving plan. For example, the robot 1000a and the autonomous driving vehicle 1000b with the autonomous driving function may determine one or more of a travel route or a driving plan using information sensed through the lidar, radar, and camera.

The robot 1000a interacting with the autonomous driving vehicle 1000b may be embodied as a separate device from the autonomous driving vehicle 1000b and may be linked to the autonomous driving function while being disposed internally or externally with respect to the autonomous driving vehicle 1000b. Thus, the robot 1000a may perform an operation associated with a user seated in the autonomous driving vehicle 1000b.

In this regard, the robot 1000a interacting with the autonomous driving vehicle 1000b may obtain sensor information on behalf of the autonomous driving vehicle 1000b and provide the information to the autonomous driving vehicle 1000b. Alternatively, the robot 1000a may acquire sensor information, and generate surrounding environment information or object information based on the sensor information, and provide the generated information to the autonomous driving vehicle 1000b. In this manner, the robot 1000a may control or assist the autonomous driving function of the autonomous driving vehicle 1000b.

Alternatively, the robot 1000a interacting with the autonomous driving vehicle 1000b may monitor the user mounted in the autonomous driving vehicle 1000b or control a function of the autonomous driving vehicle 1000b via interaction with the user. For example, when the robot 1000a determines that the driver is drowsy, the autonomous driving function of the autonomous driving vehicle 1000b may be activated by the robot 1000a or control of the driving unit of the autonomous driving vehicle 1000b may be assisted by the robot 1000a.

In this regard, the function of the autonomous driving vehicle 1000b as controlled by the robot 1000a may include not only the autonomous driving function but also a function provided by a navigation system or an audio system provided inside the autonomous driving vehicle 1000b.

Alternatively, the robot 1000a interacting with the autonomous driving vehicle 1000b may provide information to the autonomous driving vehicle 1000b or may assist with the function of the autonomous driving vehicle 1000b, while being disposed outside of the autonomous driving vehicle 1000b. For example, when the robot acts as a smart traffic light, the robot 1000a may provide traffic information including signal information to the autonomous driving vehicle 1000b. When the robot acts as an automatic electric charger of an electric vehicle, the robot 1000a may interact with the autonomous driving vehicle 1000b such that an electric charger may be automatically connected to a charging port of the autonomous driving vehicle 1000b.

In one example, the robot 1000a may have AI technology and XR technology applied thereto and may be implemented as a guide robot, a transport robot, a cleaning robot, a wearable robot, an entertainment robot, a pet robot, an unmanned flying robot, or a drone.

The robot 1000a with the XR technology applied thereto may refer to a robot that is subject to control/interaction in a range of an XR image. In this case, the robot 1000a may be distinguished from the XR device 1000c and may be associated with the XR device 1000c.

When the robot 1000a subject to control/interaction in the XR image range acquires sensor information from sensors including cameras, etc. the robot 1000a or XR device 1000c creates an XR image based on the sensor information. The XR device 1000c may output the generated XR image. Then, the robot 1000a may operate based on a control signal input via the XR device 1000c or based on the user interaction.

For example, the user may check the XR image corresponding to a time point about the robot 1000a as remotely connected via an external device such as the XR device 1000c. The user may use the XR device 1000c for the interaction with the robot to adjust an autonomous travel route of the robot 1000a, control an operation or driving thereof, or check information regarding surrounding objects around the robot.

In one example, the autonomous driving vehicle 1000b may have AI technology and XR technology applied thereto and thus may be implemented as a mobile robot, a vehicle, an unmanned aerial vehicle, etc.

The autonomous driving vehicle 1000b to which XR technology is applied may refer to an autonomous driving vehicle having means for providing an XR image, or an autonomous driving vehicle to be controlled/interacted in the XR image range. In particular, the autonomous driving vehicle 1000b to be controlled/interacted in the XR image range may be distinguished from the XR device 1000c and may be associated with the XR device 1000c.

The autonomous driving vehicle 1000b having the means for providing an XR image acquires sensor information from sensors including a camera, etc. The XR image may be generated based on the acquired sensor information using the means. The XR image may be output to the user. For example, the autonomous driving vehicle 1000b may include a HUD and thus output an XR image, thereby providing a passenger with an XR object corresponding to a real object or an object on a screen.

In this regard, when the XR object is output on the HUD, at least a portion of the XR object may be output to overlap an actual object to which the occupant's eyes are directed. On the other hand, when the XR object is output on a display provided inside the autonomous driving vehicle 1000b, at least a portion of the XR object may be output to overlap the object on the screen. For example, the autonomous driving vehicle 1000b may output XR objects corresponding to objects such as lanes, other vehicles, traffic lights, traffic signs, motorcycles, pedestrians, buildings, and the like.

When the autonomous driving vehicle 1000b subject to the control/interaction in the XR image range acquires sensor information from the sensors including the camera, etc., the autonomous driving vehicle 1000b or XR device 1000c generates an XR image based on the sensor information. The XR device 1000c may output the generated XR image. Then, the autonomous driving vehicle 1000b may operate based on a control signal input through an external device such as the XR device 1000c or based on the user interaction

In one example, the communication between the autonomous driving vehicle 200, the adjacent vehicle, and the server 100 as described earlier (see, e.g., FIG. 2) may be performed over a 5G network. In other words, messages transmitted and received during communication may be relayed over the 5G network.

Hereinafter, referring to FIG. 12 to FIG. 17, a data communication process over the 5G network will be described in more detail with reference to various embodiments.

Referring to FIG. 12, a vehicle 200 driving in a normal lane may transmit road situation information and surrounding situation information to the server 100 at S10. The server 100 may check each lane score for the vehicle 200 at S11, and transmit an optimal travel route to the vehicle 200 at S12. Upon receiving the optimal travel route signal, the vehicle 200 may switch to a lane having the highest score from a lane on which the vehicle is currently driving (or operating).

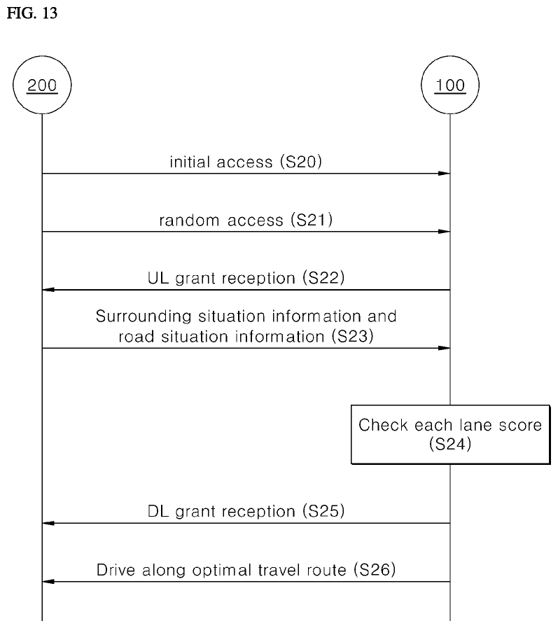

FIG. 13 shows an example of an application communication process between a vehicle and a server in a 5G communication system.

The vehicle 200 may perform an initial access procedure with the server 100 at S20.

The initial access procedure may include a cell search for acquiring a downlink (DL) operation, a process of acquiring system information, and the like.

Then, the vehicle 200 may perform a random access procedure with the server 100 at S21.

The random access procedure may include a preamble transmission, a random access response reception process, and the like for uplink (UL) sync acquisition, or UL data transmission.

Then, the server 100 may send to the vehicle 200 a UL grant for scheduling transmission of road situation information and surrounding situation information at S22.

The UL Grant reception may include a process of receiving time/frequency resource scheduling for transmitting UL data to the server 100.

Then, the vehicle 200 may transmit the road situation information and surrounding situation information to the server 100 based on the UL grant at S23.

Then, the server 100 may perform an operation of calculating each lane score for transmitting an optimal travel route based on the road situation information and surrounding situation information at S24.

Then, the vehicle 200 may receive a DL grant on a physical downlink control channel to receive the road situation information and surrounding situation information from the server 100 at S25.

Then, the server 100 may send the optimal travel route to the vehicle 200 based on the DL grant at S26.

In one example, in FIG. 13, an example in which the initial access process and random access process between the vehicle 200 and the server 100 and the downlink grant receiving process over the 5G communication are combined with each other is illustrated, based, by way of example, on S20 to S26. However, it is understood that embodiments of the present disclosure are not limited thereto.

For example, the initial access procedure and/or random access procedure may be performed via S20, S22, S23, S24, and S25. Alternatively, for example, the initial access procedure and/or random access procedure may be performed via S21, S22, S23, S24, and S26.

Further, it is understood that FIG. 13 illustrates operation of the vehicle 200 according to at least one embodiment using S20 to S26. However, it is understood that embodiments of the present disclosure are not limited thereto.

For example, the operation of the vehicle 200 may include selective combinations between S20, S21, S22, and S25 and S23 and S26. Alternatively, for example, the operation of the vehicle 200 may include S21, S22, S23, and S26. Alternatively, for example, the operation of the vehicle 200 operation may include S20, S21, S23, and S26. Alternatively, for example, the operation of the vehicle 200 operation may include S22, S23, S25, and S26.

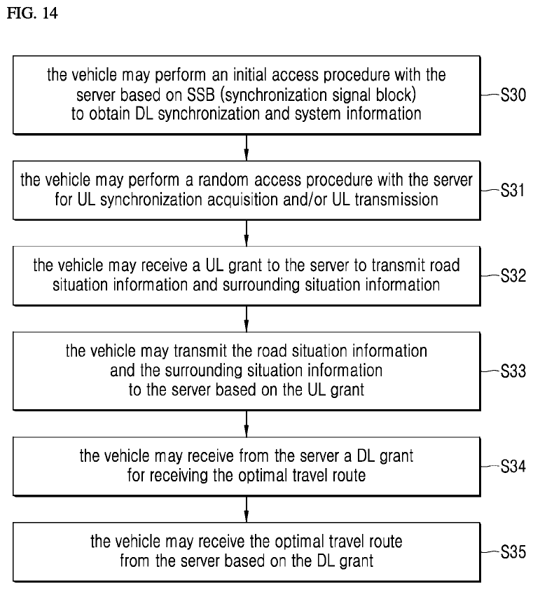

FIG. 14 to FIG. 17 show examples of an operation process of a vehicle using 5G communication according to various embodiments.

First, referring to FIG. 14, the vehicle 200 may perform an initial access procedure with the server 100 based on SSB (synchronization signal block) to obtain DL synchronization and system information at S30.

Then, the vehicle 200 may perform a random access procedure with the server 100 for UL synchronization acquisition and/or UL transmission at S31.

Then, the vehicle 200 may receive a UL grant to the server 100 to transmit road situation information and surrounding situation information at S32.

Then, the vehicle 200 may transmit the road situation information and the surrounding situation information to the server 100 based on the UL grant at S33.

Then, the vehicle 200 may receive from the server 100 a DL grant for receiving the optimal travel route at S34.

Then, the vehicle 200 may receive the optimal travel route from the server 100 based on the DL grant at S35.

A beam management (BM) process may be added to S30. A beam failure recovery process associated with PRACH (physical random access channel) transmission may be added to S31. A QCL (quasi co-location) relationship with respect to a beam reception direction of the PDCCH including the UL grant may be added to S32. A QCL relationship with respect to a beam transmission direction of a PUCCH (physical uplink control channel)/PUSCH (physical uplink shared channel) including an entry request signal may be added to S33. Further, a QCL relationship with respect to a beam reception direction of the PDCCH including the DL grant may be added to S34.

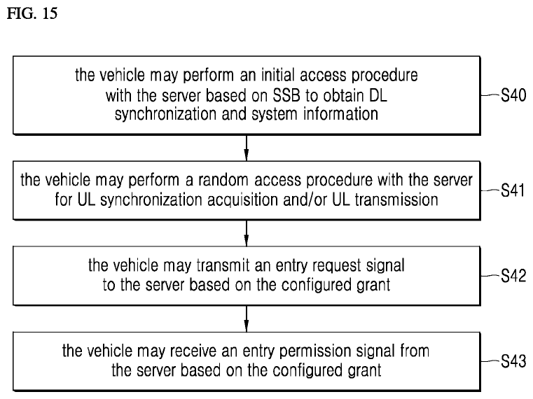

Referring to FIG. 15, the vehicle 200 may perform an initial access procedure with the server 100 based on SSB to obtain DL synchronization and system information at S40.

Then, the vehicle 200 may perform a random access procedure with the server 100 for UL synchronization acquisition and/or UL transmission at S41.

Then, the vehicle 200 may transmit an entry request signal to the server 100 based on the configured grant at S42. In other words, instead of receiving the UL grant from the server 100, the vehicle may transmit the entry request signal to the server 100 based on the configured grant.

Then, the vehicle 200 may receive an entry permission signal from the server 100 based on the configured grant at S43.

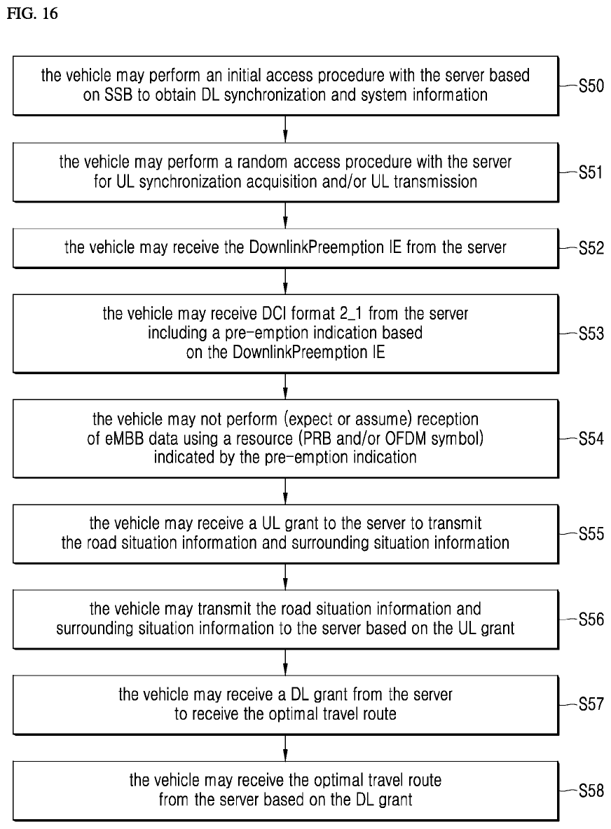

Referring to FIG. 16, the vehicle 200 may perform an initial access procedure with the server 100 based on SSB to obtain DL synchronization and system information at S50.

Then, the vehicle 200 may perform a random access procedure with the server 100 for UL synchronization acquisition and/or UL transmission at S51.

Then, the vehicle 200 may receive the DownlinkPreemption IE (information element) from the server 100 at S52.

Then, the vehicle 200 may receive DCI (downlink control information) format 2_1 from the server 100 including a pre-emption indication based on the DownlinkPreemption IE at S53.

Then, the vehicle 200 may not perform (expect or assume) reception of eMBB (enhanced Mobile Broadband) data using a resource (PRB (physical resource block) and/or OFDM symbol) indicated by the pre-emption indication at S54.

Then, the vehicle 200 may receive a UL grant to the server 100 to transmit the road situation information and surrounding situation information at S55.

Then, the vehicle 200 may transmit the road situation information and surrounding situation information to the server 100 based on the UL grant at S56.

Then, the vehicle 200 may receive a DL grant from the server 100 to receive the optimal travel route at S57.

Then, the vehicle 200 may receive the optimal travel route from the server 100 based on the DL grant at S58.

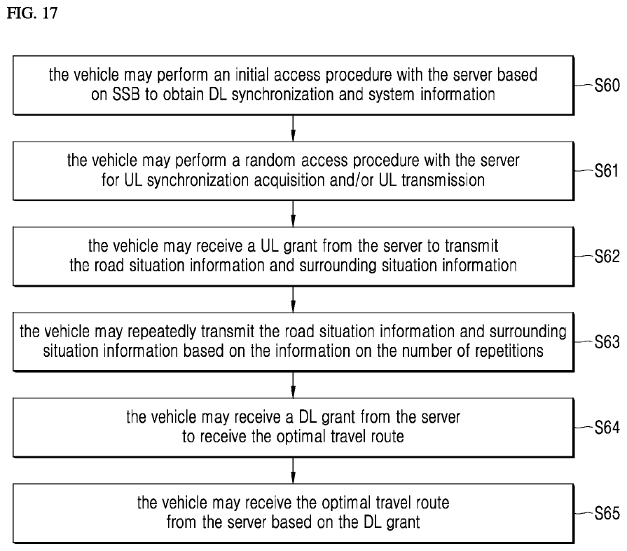

Referring to FIG. 17, the vehicle 200 may perform an initial access procedure with the server 100 based on SSB to obtain DL synchronization and system information at S60.

Then, the vehicle 200 may perform a random access procedure with the server 100 for UL synchronization acquisition and/or UL transmission at S61.

Then, the vehicle 200 may receive a UL grant from the server 100 to transmit the road situation information and surrounding situation information at S62. The UL grant includes information on the number of repetitions of transmission of the road situation information and surrounding situation information.

Then, the vehicle 200 may repeatedly transmit the road situation information and surrounding situation information based on the information on the number of repetitions at S63. That is, the vehicle 200 may transmit the road situation information and surrounding situation information to the server 100 based on the UL grant.

In this regard, the repeated transmission of the road situation information and surrounding situation information may be performed using frequency hopping. A first entry request signal may be transmitted using a first frequency resource, and a second entry request signal may be transmitted using a second frequency resource.

The entry request signal may be transmitted over a narrowband of 6 RBs (Resource Block) or 1 RB (Resource Block).

Then, the vehicle 200 may receive a DL grant from the server 100 to receive the optimal travel route at S64.

Then, the vehicle 200 may receive the optimal travel route from the server 100 based on the DL grant at S65.

Although in the embodiments illustrated in FIG. 13 to FIG. 17, data communication between the vehicle 200 and the server 100 involves the transmission and reception of the road situation information and surrounding situation information and the optimum travel route by way of example, embodiments of the present disclosure are not limited thereto. The above-mentioned data communication may be applied to any signal communicated between the vehicle 200 and server 100.

The 5G communication technology as described above may be supplemented to specify or clarify the data communication method for the vehicle 200 as described herein. However, as mentioned above, embodiments of the data communication method for the vehicle 200 are not limited thereto. The vehicle 200 may perform data communication using various methods used in the art.

Although embodiments of the present disclosure have been described with reference to the drawings and embodiments as exemplified above, the present disclosure is not limited to the embodiments and the drawings disclosed herein. It is understood that various modifications may be made thereto by a person skilled in the art to which the scope of the present disclosure pertains. In addition, it should be appreciated that effects to be achieved from configurations of the present disclosure but not expressly mentioned may be obtained.

What is claimed is:

1. A device for configuring a travel route, the device comprising:
an information receiver configured to receive at least one of surrounding situation information or road situation information from a cloud;
a score calculating unit configured to calculate a score about each of a plurality of lanes of a road based on the at least one of the surrounding situation information or the road situation information; and
a travel route managing unit configured to configure the travel route based the calculated scores.

2. The device of claim 1, wherein the surrounding situation information includes information about at least one of a vehicle or a pedestrian on the road, and
wherein the road situation information includes information about at least one of a road surface state, an accident, or a construction/working section, wherein the road surface state includes at least one of a slippery state, a frozen state or a damaged state.

3. The device of claim 1, wherein the score calculating unit is further configured to:
divide a road into the plurality of lanes along a route from a starting point to a destination; and
calculate the score about each of the plurality of lanes using at least one of the surrounding situation information or the road situation information as a parameter.

4. The device of claim 3, wherein the score calculating unit is further configured to:
calculate at least one condition value corresponding to a level of the parameter for each of the plurality of lanes; and
sum the at least condition value for each of the plurality of lanes to calculate the score about the lane.

5. The device of claim 1, wherein the score calculating unit is further configured to apply a weight corresponding to a preference mode to each of the scores to calculate preference-based lane scores, wherein different preference modes have different weights.

6. The device of claim 5, wherein the preference mode includes at least one of a ride comfort mode, a fuel consumption mode, a vehicle damage mode, or a driving time mode.

7. The device of claim 3, wherein the score calculating unit is further configured to apply a weight corresponding to a preference mode to each of the scores to calculate preference-based lane scores, wherein different preference modes have different weights for each parameter.

8. The device of claim 7, wherein for each parameter, a value of a weight corresponding to a specific preference mode is proportional to an influence level of each parameter on the specific preference mode.

9. The device of claim 1, wherein the score calculating unit is further configured to calculate a lane score for each of three situations, wherein the three situations include:
a first situation where a vehicle keeps a current lane;
a second situation where the vehicle switches to a left lane with respect to the current lane; and
a third situation where the vehicle switches to a right lane with respect to the current lane.

10. The device of claim 1, wherein the travel route managing unit is further configured to include a lane of the plurality of lanes having a highest lane score into the travel route.

11. A method for configuring a travel route, the method comprising:
receiving at least one of surrounding situation information or road situation information from a cloud;
calculating a score about each of a plurality of lanes of a road based on the at least one of the surrounding situation information or the road situation information; and
configuring the travel route based on the calculated scores.

12. The method of claim 11, wherein the surrounding situation information includes information about at least one of a vehicle or a pedestrian on the road, and
wherein the road situation information includes information about at least one of a road surface state, an accident, or a construction/working section, wherein the road surface state includes at least one of a slippery state, a frozen state or a damaged state.

13. The method of claim 11, wherein calculating the score about each of the plurality of lanes includes:
dividing a road into the plurality of lanes along a route from a starting point to a destination; and
calculating the score about each of the plurality of lanes using at least one of the surrounding situation information or the road situation information as a parameter.

14. The method of claim 13, wherein calculating the score about each of the plurality of lanes further includes:
calculating at least one condition value corresponding to a level of the parameter for each of the plurality of lanes; and
summing the at least condition value for each of the plurality of lanes to calculate the score about the lane.

15. The method of claim 11, wherein calculating the score about each of the plurality of lanes includes applying a weight corresponding to a preference mode to each of the scores to calculate preference-based lane scores, wherein different preference modes have different weights.

16. The method of claim 5, wherein the preference mode includes at least one of a ride comfort mode, a fuel consumption mode, a vehicle damage mode, or a driving time mode.

17. The method of claim 13, wherein calculating the score about each of the plurality of lanes includes applying a weight corresponding to a preference mode to each of the scores to calculate preference-based lane scores, wherein different preference modes have different weights for each parameter.

18. The method of claim 17, wherein for each parameter, a value of a weight corresponding to a specific preference mode is proportional to an influence level of each parameter on the specific preference mode.

19. The method of claim 11, wherein calculating the score about each of the plurality of lanes includes calculating a lane score for each of three situations, wherein the three situations includes:
a first situation where a vehicle keeps a current lane;
a second situation where the vehicle switches to a left lane with respect to the current lane; and
a third situation where the vehicle switches to a right lane with respect to the current lane.

20. The method of claim 11, wherein receiving the at least one of the surrounding situation information or road situation information includes receiving the at least one of the surrounding situation information or road situation information over a 5-th generation (5G) network, and
wherein the method further includes transmitting the configured travel route to a target vehicle over the 5G network.
